(19) United States
(12) Patent Application Publication
(10) Pub. No.: US 2010/0231066 A1
(43) Pub. Date: Sep. 16, 2010

(54) ELECTRICAL MACHINE WITH PERMANENT MAGNETS

(75) Inventor: Olaf Körner, Nurnberg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, 80333 Munchen (DE)

(21) Appl. No.: 12/067,125

(22) PCT Filed: Aug. 15, 2006
(86) PCT No.: PCT/EP2006/065302

§ 371 Date: Jun. 3, 2010

(30) Foreign Application Priority Data
Sep. 16, 2005 (DE) 10 2005 044 327.3

(51) Int. Cl. H02K 1/32; H02K 1/20

(52) U.S. Cl. 310/61

(57) ABSTRACT

Electrical machine (1) having a stator (3), which has axially extending cooling channels (8) in the laminate stack and/or cooling channels (9) extending between the stator and a housing, having a rotor (20), whose laminate stack (19) has an internal bore or is positioned on a hub structure (7) having an internal bore, wherein permanent magnets (14) are arranged in or on the laminate stack (19) of the rotor (20), wherein at least one axial-flow fan (4) is provided in the internal bore of the rotor (20), the air flow produced by said axial-flow fan, once it has passed through the rotor (20), by means of flowing through a suitable apparatus (13) achieves a nozzle effect which, owing to the venturi effect, brings about an air flow through the cooling channels (8) arranged in the stator (3). The remanence of the permanent magnets (14) is therefore positively influenced.

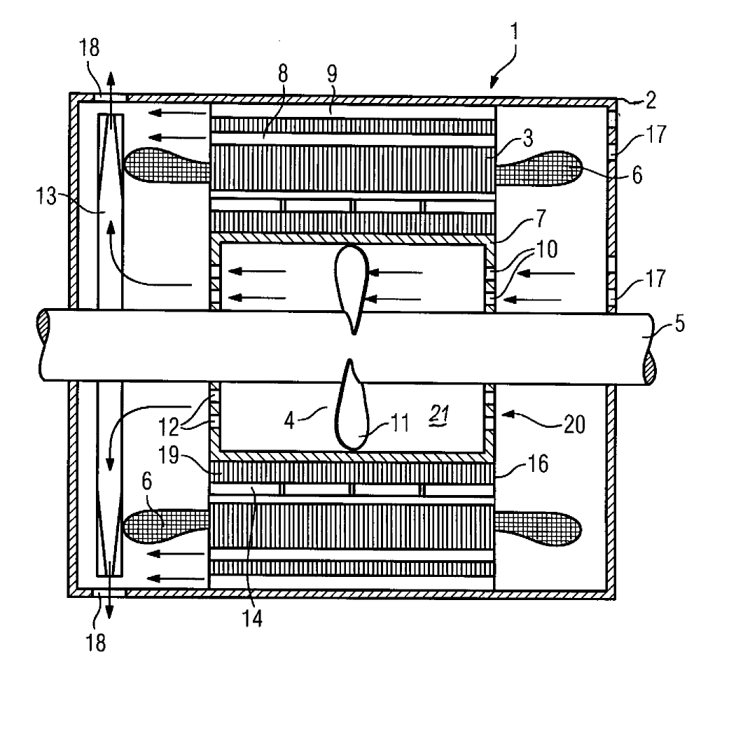

The invention relates to an electrical machine having a stator which has axially running cooling channels in the laminated core and/or between the stator and a housing, a rotor whose laminated core is positioned on a hub structure with an internal bore, with permanent magnets being arranged in or on the laminated core.

Electrical machines, in particular electrical machines with permanent magnets, are designed such that the permanent magnets are at a temperature level which is as constant as possible, since their remanence is temperature-dependent. The magnetic flux in the electrical machine varies as a result of this temperature-dependent remanence of the permanent magnets since this reduces the induced voltage during generator operation, and reduces the electrical torque which can be produced during motor operation.

Until now, radial fans have been used in electrical machines such as these, but these lead to axial lengthening of the electrical machine. A further possibility is to use separate external fans, although this results in higher investment costs and a larger physical space.

DE 30 35 775 A1 discloses a fan which sucks air in, is connected downstream from the stator and the rotor and sucks the cooling air through the existing cooling channels. However, this likewise unnecessarily axially lengthens the electrical machine.

Against this background, the invention is based on the object of providing an electrical machine which ensures adequate cooling, in particular of the rotor, with a compact form. A further aim is to keep the overall temperature level of the rotor at a temperature which is as constant as possible, in order to compensate for the temperature dependency of the remanence of the permanent magnets.

The stated object is achieved by an electrical machine having:
a stator which has axially running cooling channels in the laminated core and/or has cooling channels running between the stator and a housing,
a rotor whose laminated core has an internal bore or is positioned on a hub structure with an internal bore,
with permanent magnets being arranged in or on the laminated core,
with at least one axial fan being provided in the internal bore in the rotor, whose air flow that is produced achieves a nozzle effect by flowing through a suitable apparatus after passing through the rotor, which nozzle effect results in an air flow in the cooling channels which are arranged in the stator, by virtue of the Venturi effect.

Provision of a relatively high air flow rate through the rotor via the internal bore leads to comparatively good cooling of the permanent magnets which are arranged in the laminated core or on the circumference of the rotor and whose remanence is temperature-dependent. This prevents the magnetic flux in the electrical machine varying with the magnet temperature and thus reducing the induced voltage and the electrical torque that can be produced respectively in and by the electrical machine.

This is particularly advantageous, especially when the electrical machine is being operated as a generator from a diode rectifier. On the other hand, however, this means that the electrical machine should not actually be cooled down when being operated as a generator even when at rest.

In order to achieve a uniform temperature in the rotor and in particular on the permanent magnets in these various operating states of the electrical machine, additional electrical heating is advantageously provided for the rotor, when at rest, for the electrical machine according to the invention with permanent magnets and a diode rectifier. This prevents the electrical machine from cooling down as a result of the lack of electrical losses and iron losses in the rotor.

There is no need to supply electrical power when the electrical machine is in operation, that is to say when it is rotating, so that there is no need for contacts that are subject to wear.

In a further embodiment, the hub structure itself has ribs that are cast on it and are provided for this purpose, located in the internal bore in the rotor, forming an axial fan, providing an axial air flow in the internal bore in the rotor.

The air now flows through the internal bore in the rotor and, at the end of the rotor, may be deflected radially over the end windings of the stator. A suitable apparatus, in particular nozzles, especially in the area of the stator, can be used to produce a reduced pressure, that is achieved by the Venturi effect, at this end of the stator, so that this results in an air flow via the existing cooling channels in the laminated core of the stator and/or in cooling channels between the stator and a housing, contributing to cooling of the stator.

Air can likewise be sucked in through the air gap in the electrical machine, by means of the Venturi effect, such that efficient cooling is achieved, particularly for permanent magnets which are arranged on the circumference of the rotor. Mechanically or electrically filtered cooling air is required, inter alia, in order in this case to avoid accumulation of magnetic particles in the cooling air on the permanent magnets.

In one particularly preferred embodiment, temperature sensors are arranged in the electrical machine and automatically produce a temperature profile which is as constant as possible in the electrical machine and, in particular, in the rotor. In this case, the temperatures are detected in the area of the permanent magnets on the rotor and on the stator, and cooling air or electrical heating is provided accordingly.

The invention and further advantageous refinements of the invention will be explained in more detail with respect to one schematically illustrated exemplary embodiment.

The FIGURE shows a schematically illustrated electrical machine 1, in particular a synchronous machine with permanent magnet excitation and accommodated in a housing 2. The electrical machine has a stator 3, in whose slots there is a winding system, which forms the end winding 6 on the end faces of the stator. The winding system is, in particular, a three-phase winding system, in which case not only traditional winding techniques, that is to say fractional-pitch windings, but also tooth-wound coils can be used.

Tooth-wound coils are coils which each surround only one mechanical tooth on the stator 3. The stator 3 is laminated and has essentially axially running cooling channels 8. Cooling channels 9 are likewise provided between the housing 2 and the stator 3, although these are not absolutely essential in a further embodiment and for understanding of the operation of the invention.

A shaft 5 has a hub structure 7 on which a laminated core 19 is fixed to the hub structure 7 by attachment methods, for example shrinking, which are known per se.

It is also possible to provide the laminated core 19 with at least one corresponding internal bore. A plurality of bores with parallel axes are advantageously provided.

The laminated core 19 of the rotor 20 has permanent magnets 14 on its external circumference, and these are fixed to the rotor 20 by suitable attachment means, for example adhesive and/or a binding tape 16.

In another embodiment, the permanent magnets 14 are arranged within the laminated core 19 in the rotor 20, that is to say these are buried permanent magnets 14.

The permanent magnets 14 can also be fixed and placed directly on the hub structure 7, that is to say without the additional laminated core 19 of the rotor 20.

The hub structure 7 is hollow such that means are provided within the cavity to provide an axial air flow during operation of the electrical machine. These ventilation means may be fan blades 11 which suck air into the machine area, and therefore into the internal bore, via the inlet air channels 17 during rotation of the rotor 20. This creates at least one axial fan 4 in the internal bore in the rotor 20. The air flow via the cooling channels 10 and 12 in the rotor 20 ensures adequate ventilation and temperature control for the permanent magnets 14 for the rotor 20.

The axial fan 4 may be designed either for external ventilation or for self-ventilation. In the case of self-ventilation, means which are similar to fan blades are formed as part of the cavity in the hub structure.

The design according to the invention creates a constant remanence for the permanent magnets 14, with an advantageous effect on the profile of the induced voltage and the torque response of the electrical machine 1. After leaving the rotor 20, the cooling air flow is passed to an apparatus 13 in which the cooling air which has been heated in the rotor 20 is converted to a radial flow to the outside via openings 18 before it emerges axially from the rotor 20.

Because of the Venturi effect, the increased flow speed of the emerging cooling air flow produces a suction effect, which results in a further cooling air flow through the cooling channel 8 and, possibly, the cooling channel 9, and thus at the same time ensures cooling of the stator 3.

A cooling concept such as this is particularly advantageous for electrical machines which are used as generators and which require exactly constant temperatures. This applies, for example, to electrical tractive units, and in particular to diesel locomotives.

1-6. (canceled)

7. An electrical machine, comprising:
a housing;
a stator accommodated in the housing and having a laminated core, said stator having at least one of axial cooling channels in the laminated core and cooling channels between the stator and the housing;
a rotor including a laminated core and having an internal bore;
permanent magnets arranged in or on the laminated core of the rotor;
at least one axial fan provided in the internal bore in the rotor and producing an air flow for passage through the rotor; and
means for producing a nozzle effect as the air flow passes there through, resulting in a venturi effect to cause air to flow in the cooling channels.

8. The electrical machine of claim 7, wherein the laminated core of the rotor is formed with the internal bore.

9. The electrical machine of claim 7, wherein the rotor includes a hub structure which is formed with internal bore.

10. The electrical machine of claim 9, wherein the axial fan is part of the hub structure to form a single-piece configuration.

11. The electrical machine of claim 7, wherein the axial fan has angled blades received in the internal bore.

12. The electrical machine of claim 7, wherein the stator has additional water jacket cooling.

13. The electrical machine of claim 7, further comprising an electrical heater arranged in the laminated core of the rotor.

14. The electrical machine of claim 7, further comprising temperature sensors on at least one member selected from the group consisting of rotor and stator, for ascertaining the temperature of the permanent magnets and other hot spots and autonomously providing heating or cooling power.

15. The electrical machine of claim 7, wherein the means for producing a nozzle effect include a deflector for deflecting the air flow incoming from the rotor in axial direction to flow in a radial direction for exiting through an opening of the housing in alignment with the deflector.

16. The electrical machine of claim 7, wherein the means for producing a nozzle effect have opposite tapered ends to form constrictions to establish the venturi effect.
